(19) United States
(12) Patent Application Publication
(10) Pub. No.: US 2010/0101361 A1
(43) Pub. Date: Apr. 29, 2010

(54) APPARATUS FOR MOVING AN OBJECT IN NANOMETER AND METHOD THEREOF

(76) Inventor: Hilaal Alam, Bangalore (IN)

Correspondence Address: BUTZEL LONG;IP DOCKETING DEPT, 350 SOUTH MAIN STREET, SUITE 300, ANN ARBOR, MI, 48104, US

(21) Appl. No.: 11/577,210

(22) PCT Filed: Sep. 13, 2006
(86) PCT No.: PCT/IN06/00351

§ 371 Date: Dec. 22, 2009

(30) Foreign Application Priority Data
Sep. 14, 2005 (IN) 1287/CHE/2005

(51) Int. Cl. B23Q 1/34; G12B 5/00; B23P 11/00

(52) U.S. Cl. 74/490.08; 29/428

(57) ABSTRACT

The nanopositioner that consists of two parallelograms is formed in inverted manner to each other. The amplification lever from the actuator point actuates the second parallelogram, which comes from the first one. The lever and the second parallelogram are connected by means of flexural hinges. This entire system is a monolithic structure as shown in FIG. 5. When the actuator expands, the actuator lever actuates the second parallelogram at the center or middle of its column length. This causes the displacement of both the parallelograms. Since the two parallelograms are perpendicular to each other, perpendicular deflection is reduced. Actuating at the center of the parallelogram length with amplification lever reduces the arcuate motion and linear displacement of the moving stage is obtained in the nanopositioner.

### FIELD OF THE INVENTION

The present invention is related to the flexural positioning technology with nanometer resolution. Moving an object in nanometer resolution in desired direction without any parasitic displacements.

### BACKGROUND OF THE INVENTION AND PRIOR ART

Positioning objects such as lenses, fibers, tools, sensors etc., with respect to the nanometer resolution is a challenging one. With the advent of the technology in various fields such as photonics, optics, semiconductor, microscopy etc., the requirement for precise positioning with nanometer resolution is inevitable.

When objects are moved in a nanometer range, there would be additional displacements from undesired axes, which are known as parasitic errors. These errors prevent the objects from moving in a straight line and results in deviation from the desired targets. These also prevent the system from moving to the full range of displacement. Out-of-plane movement, Perpendicular deflection and arcuate motion are the common errors occurring in any nanopositioners. Controlling the design/manufacturing processes, out-of-plane movement can be minimized. By integrating two parallelograms in perpendicular direction, the second error can be reduced. However, out-of-plane movement and Perpendicular deflection are occurring in a straight line whereas the arcuate motion causes objects to move in a curved path.

If the actuator is placed in the center of the parallelogram length, the displacement of the stage is limited to the expansion length of the actuator. For larger displacement, the actuator size becomes bigger. By giving actuation at the center of parallelogram length with an amplifier lever, the arcuate motion of the moving stage is reduced to the great extent. Apart from this, the desired displacement of the stage can be achieved due to the amplifier lever. Thus by having an amplifier lever extending upto the center of the parallelogram length, the larger displacement is achieved as desired and system becomes a centrally actuated one.

The invention made by Amatucci et. al. (U.S. Pat. No. 6,467,761) is the closest prior art of the invention. However, they have not discussed any issue pertaining to central actuation. They attempted to suppress the arcuate motion with two inverted parallelogram structures; not by central actuation.

The paper titled “Designing Springs for Parallel Motion” by George H. Neugebauer, Machine Design, Aug. 7, 1980, pp 119-120, indicates that actuation at the mid way along the slotted spring provides parallel motion.

When used flexural hinges, the actuation at the mid way (center) along the parallelogram is cumbersome and hence two inverted parallelograms have been used. Advantages: The arcuate motion is still present with the inverted parallelograms mechanisms. Hence by actuating at the center of the parallelogram, arcuate motion can be reduced, provided perpendicular deflection is permitted. This is the major advantage over Amatucci et. al. (U.S. Pat. No. 6,467,761).

### OBJECTS OF THE INVENTION

The primary objective of the present invention is to provide nanopositioners with pure translational or rotational movement.

Yet another object of the invention is to correct the parasitic errors caused by the arcuate deflection.

Yet another object of the present invention is “actuating at the center of the parallelogram length with amplification lever”.

Yet another objection of the invention is providing a nanopositioners by inverting the parallelograms.

Still another object of the present invention is to provide a method of minimizing the arcuate deflection by placing the actuator at the center of the parallelogram distance.

Still another objective of the present invention provides a method of minimizing the arcuate deflection by avoiding the use of expensive feed back control system.

Still another object of the invention is to develop an apparatus for micropostioning the actuator.

Still another object of the invention is usage of the arcuate deflection correction technique in various field of astronomy, data storage, medical, metrology, micro machining, microscopy, photonics, precision machining, semi conductors etc.

### STATEMENT OF THE INVENTION

The present invention relates to an apparatus for moving an object in nanometer resolution in desired direction without any parasitic displacement with pure translational and rotational movements, said apparatus comprises inverted parallelograms to work as fixed stage and moving stage, flexural hinge carved at middle of the parallelograms to connect the stages, a piezo actuator to displace the moving stage, amplification lever which comes out of the actuator and goes till the center of the parallelogram length to connect the actuator and the stages for amplifying the displacement derived from the piezo to predetermined displacement range, and mechanical stage combined with the parallelograms to transfer the motion precisely and controllably,

a method for moving an object in nanometer resolution in desired direction without any parasitic displacement with pure translational and rotational movements, said method comprises; keeping the object over a moving stage of parallelograms, deflecting amplification lever using actuator for displacement of the moving stage, actuating both parallelograms at the center of column length by deflected amplification lever, and moving the actuated parallelograms in a desired direction, and also,

a method of manufacturing an apparatus for moving an object in nanometer resolution in desired direction without any parasitic displacement with pure translational and rotational movements, said method comprises;

Connecting fixed stage and moving stage of inverted parallelograms by means of flexural hinge carved at middle of the parallelograms, Connecting an actuator and the stages by means of an amplification lever which comes out of the actuator and goes till the center of the parallelogram length for amplifying the displacement derived from the piezo to predetermined displacement range, and Combining a mechanical stage with the parallelograms to transfer the motion precisely and controllably to obtain the apparatus.

### BRIEF DESCRIPTION OF ACCOMPANYING DRAWINGS

FIG. 1 shows a Parallelogram with moving stage and fixed stage.

FIG. 2 shows Deflection of a Parallelogram When actuated other than at the center of the parallelogram length. The angular deflection of the moving stage—ARCUATE MOTION.

FIG. 3 shows Deflection of the parallelogram when actuated at the center of the parallelogram length. Arcuate motion is corrected but PERPENDICULAR DEFLECTION still exists.

FIG. 4 shows conventionalInverted Parallelogram or Compound Linear Spring: Arcuate motion (Partly) and Perpendicular deflections have been corrected.

FIG. 5 shows a nanopositioner assembly showing the various parts of the assembly showing their positioners.

FIG. 6 shows an Angular Stage.

FIG. 7 shows design of nanopositioners has been reproduced as a fine tuned model.

FIGS. 8-12 shows direction of displacement in X axis.

FIGS. 13-17 shows direction of displacement in Y axis.

FIG. 18 shows the fringe that represents the measurement done with Laser Interferometry whose resolution is less than 1 nm.

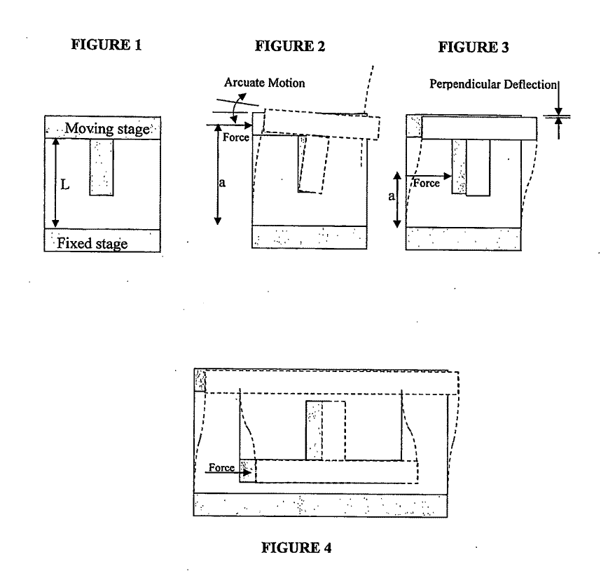

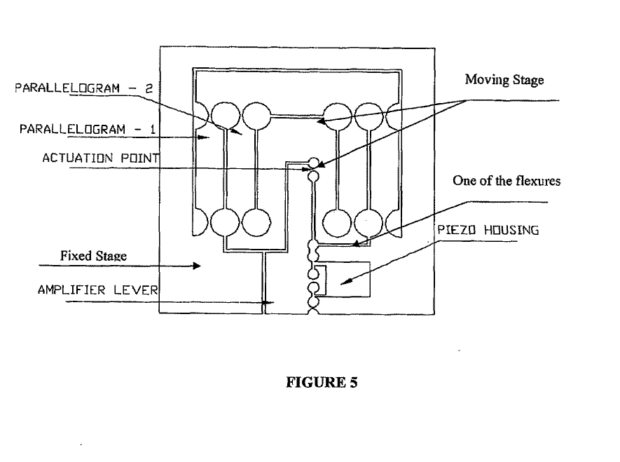

### DETAILED DESCRIPTION OF THE INVENTION

The primary embodiment of the present invention is an apparatus for moving an object in nanometer resolution in desired direction without any parasitic displacement with pure translational and rotational movements, said apparatus comprises inverted parallelograms to work as fixed stage and moving stage, flexural hinge carved at middle of the parallelograms to connect the stages, a piezo actuator to displace the moving stage, amplification lever which comes out of the actuator and goes till the center of the parallelogram length to connect the actuator and the stages for amplifying the displacement derived from the piezo to predetermined displacement range, and mechanical stage combined with the parallelograms to transfer the motion precisely and controllably.

In yet another embodiment of the present invention wherein the apparatus is monolithic.

In still another embodiment of the present invention wherein the parallelogram used is a four-bar-chain mechanism.

In still another embodiment of the present invention is the moving stage of the first parallelogram act as a fixed stage for the second parallelogram.

In still another embodiment of the present invention wherein predetermined part of moving stage is cut into step for free movement and grounded for smooth surface.

In still another embodiment of the present invention the actuator is fabricated separately and assembled into apparatus.

In still another embodiment of the present invention wherein size of the actuator is controlled with the amplification lever.

In still another embodiment of the present invention the piezo actuator acts like a motor.

In still another embodiment of the present invention the piezo actuator is piezo crystal(s) in a housing.

In still another embodiment of the present invention is a method for moving an object in nanometer resolution in desired direction without any parasitic displacement with pure translational and rotational movements, said method comprises steps of; keeping the object over a moving stage of parallelograms, deflecting amplification lever using actuator for displacement of the moving stage, actuating both parallelograms at the center of column length by deflected amplification lever, and moving the actuated parallelograms in a desired direction.

In still another embodiment of the present invention the parallelograms used is a four-bar-chain mechanism.

In still another embodiment of the present invention the parallelograms are inverted to each other.

In still another embodiment of the present invention the moving stage of the first parallelogram acts as a fixed stage for the second parallelogram.

In still another embodiment of the present invention the amplifier comes out of the actuator and goes till the center of the parallelogram length.

In still another embodiment of the present invention the apparatus does not require any feed back control systems.

In still another embodiment of the present invention the apparatus does not require additional actuators to counterbalance arcuate motion.

In still another embodiment of the present invention the amplification lever amplifies the displacement of the moving stage to predetermined range.

In still another embodiment of the present invention is a method of manufacturing an apparatus for moving an object in nanometer resolution in desired direction without any parasitic displacement with pure translational and rotational movements, said method comprises; Connecting fixed stage and moving stage of inverted parallelograms by means of flexural hinge carved at middle of the parallelograms, Connecting an actuator and the stages by means of an amplification lever which comes out of the actuator and goes till the center of the parallelogram length for amplifying the displacement derived from the piezo to predetermined displacement range, and Combining a mechanical stage with the parallelograms to transfer the motion precisely and controllably to obtain the apparatus.

The exact expression of the novelty of the invention is, “actuating at the center of the parallelogram length with amplification lever”. The concept we patent here is the design of central actuation of secondary or inverted parallelogram with amplification lever.

According to theory the arcuate motion can be determined as follows,

Arcuate motion=[2(L−2a) t²](x)/b²l²]→ Eq. (1)

Where L=length of the parallelogram column length
a=height of actuation
t=thickness of the flexure
b=inter-column length,
x=displacement

When the height of actuation become halve the length of the parallelogram height (FIG. 3),

a=L/2

Thus the arcuate motion becomes zero theoretically.

FIG. 4 shows conventional Inverted Parallelogram or Compound Linear Spring: Arcuate motion (Partly) and Perpendicular deflections have been corrected.

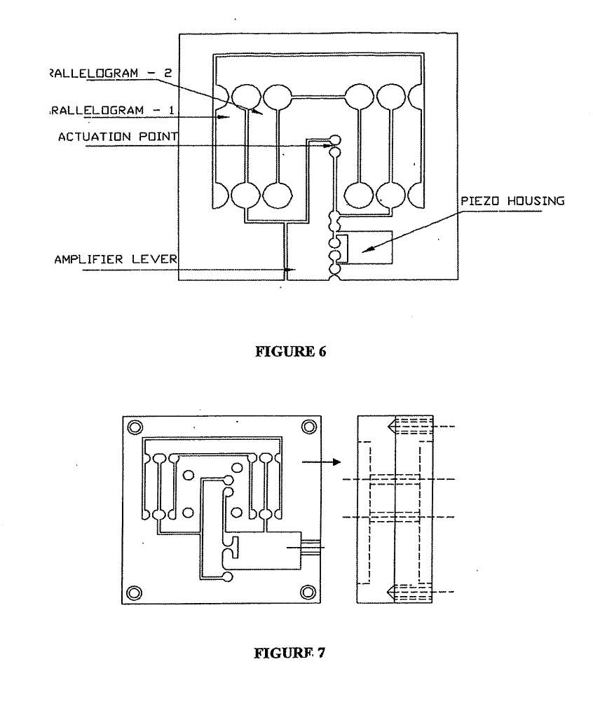

In our design, (using an inverted parallelogram to reduce the perpendicular deflection—for a linear stage inverted parallelogram is required. If we want angular displacement, inverted parallelogram can be removed. So inverted parallelogram is not concerned one for us. In an angular stage only one parallelogram is used with amplification lever, FIG. 6), force is applied (actuated) at the center of the parallelogram length using the amplification lever. It has not been implemented in the monolithic stages (even in inverted parallelogram) because of the complexity of the designs. Also in monolithic stages, amplification levers are used for displacement amplifications only. By moving and positioning at appropriate location the amplification-lever can be used to actuate at the center of the parallelogram length as shown in the following figure. The parallelogram used is a basically a four-bar-chain mechanism. The nanopositioner has a couple of parallelograms inverted to each other. A parallelogram in a nanopositioner consists of a fixed stage and moving stage. The moving and the fixed stages are connected by means of flexural columns to form a parallelogram monolithically. One end of the parallelogram is at the stationary part and the other end—moving stage—can be moved freely. The objects are kept over the moving stage. The next parallelogram comes out of the moving stage of the first parallelogram. The moving stage of the first parallelogram acts as a fixed stage for the second parallelogram. This arrangement gives a good rectilinear displacement.

The flexural hinge carved at the middle, is actuated by an “amplifier-lever”. This principle is applied in the nanopositioner in order to achieve the linear displacement at the moving stage of the second parallelogram. The one of the ways to reduce the arcuate motion is to actuate the systems at the middle of the column length.

When the actuator expands to actuate the stage, the lever amplifies the displacement and the force is transferred to the actuation point. The flexural hinge at the actuation point deforms and actuates the stage at the center. This causes both parallelogram to move along with the actuator. The perpendicular deflection occurs at each parallelogram along with the linear displacement. Since both the parallelograms are perpendicular to each other, the perpendicular deflection gets cancelled out to provide linear displacement. Yet, there is an arcuate motion—which forms a curved path—in the respective moving stage. This is due to the actuation point located away from the middle of the parallelogram length. When moving the actuation point at the middle by means of a lever that amplifies the displacement, the arcuate motion is reduced to the great extent.

The arcuate deflection is minimized by placing the actuation point right at the center. This is achieved with either by placing the actuator itself at center or using the amplifier lever. Placing the actuator at the center limits the displacement of the stage.

Hence by using amplifier lever, displacement can be amplified further, and at the same time central actuation is made possible. An amplifier comes out of the actuator (piezo) house and goes till the middle of the parallelogram length.

The main advantage of difference between the actuator placing the centre of the parallelogram length and usage of the amplifier lever is that the desired amount of displacement can be obtained with the same actuator.

The materials such as Phosphor bronze or stainless steels can be used as raw materials for nanopositioners. For free movement of the moving stage, some portion of the stage is cut into step using milling machine and ground for smooth surface. Using wirecut EDM parallelogram structures are carved out with 5-micron tolerance. The actuator is fabricated separately and assembled with nanopositioner. This entire set up is tested using an interferometry kit for its performance.

In terms of manufacturing and construction, various traditional manufacturing processes like milling, shaping, high speed drilling and wire cut computer controlled electric discharge machining is involved. These components can also be fabricated using novel bulk micro machining, photolithography. Using these manufacturing techniques it is possible to miniaturise the component for application in MEMS and NEMS devices.

However, according to the FEM simulations, the arcuate motion was present to the extent of 4% of total displacement.

The present concept is best suited in the area of fiber optics alignments, x-ray and the other sort of interferometry kits, scanning probe microscopy, semiconductor wafer defect inspection, pattern/wafer alignment during micro-lithography process, post fabrication quality inspection of wafers of sub—130 nm design rules, tool positioning, micro-machining, data-storage and metrology applications

The other alternatives to reduce or eliminate the arcuate motion are
a) to provide counterbalancing actuator
b) to incorporate the feedback systems with control algorithm
c) to provide parallelograms either side of the platform

Providing counterbalance and feedback systems will increase the cost of the systems.

The last alternative that uses parallelogram either side is bulky and tends to go out of plane due to the constraints at either side.

The present concept does not require any expensive feedback control systems. By integrating the inverted parallelograms, perpendicular deflection is eliminated.

Actuating at the center of the parallelogram length will not only enhance the linearity but also eliminate the arcuate motion.

An apparatus of the invention may comprises the following blocks.
1. Piezo crystal/crystals in a housing (collectively called a piezo actuator): Piezo actuator acts like a motor to displace the moving stage. The piezo has a characteristic to expand in size when applied with voltage.
2. Amplification lever: It amplifies the displacement obtained from piezo into the required factor.
3. Mechanical stage for minimizing parasitic errors: This is mechanical stage shown in the figure
4. Power supply to provide power to the piezo actuator: The power supply is required to apply voltage into the piezo such that piezo expands.

The piezo housing has to be designed keeping the piezo material characteristics, housing material, insulation material and preload requirement in mind. The fabrication is done using standard machining techniques like milling, shaping and drilling. The assembly is then undertaken manually. Thereafter, it is tested and calibrated using high-end interferometry equipments.

The amplification lever is designed based on the amplification required, permissible stress distribution, allowable lateral displacements. Fabrication of the lever is carried out through wire cut (electric discharge machining) EDM.

The mechanical stage is used to transfer the motion precise and controllably and this forms the crux of our claim. As discussed in detail in the previous sections, the stage has been extensively redesigned using the novel concept of central actuation and combining it with inverted parallelogram to develop system, which gives better performance (see above and below).

The power supply drives the piezo actuator. These supplies are standard off-the shelf components. The important issues while selecting the right power supply is stability of output, noise, resolution and output current.

The method of minimizing the arcuate deflection in the nanopositioner comprises the following steps.
1. The actuator deflects the amplifier lever.
2. The amplifier actuates both the parallelograms at the center of the column length.
3. Thus, deflects both the parallelograms in a desired direction.
4. The couple introduced during the actuation at the center of the column length almost eliminates the arcuate motion.

### Applications of the Invention

| SI | SEGMENT | PURPOSE |
|---|---|---|
| 1 | AERO- | Microwave Antenna Alignment |
| | SPACE | Fast Laser Beam Steering/Alignment |
| | | Resolution Enhancement, Image Stabilization |
| 2 | ASTRON- | Beam Steering/Alignment |
| | OMY | Active Secondary Mirros in Astronomical Telescopes |
| | | Laser Cavity Tuning/Stabilization |
| | | Segmented-Mirror Positioning with Linear Actuators |
| 3 | DATA | Laser Beam Stabilization (CD-ROM, DVD |
| | STORAGE | Mastering) |
| | | Head/Media Test |
| | | XY Data Test Reading/Writing |
| | | Throughput Enhancement |
| 4 | MEDICAL | Cell Tracking |
| | | Laser Beam Steering/Stabilization |
| | | Electro-Physiology, Cell Penetration |
| | | Patch Clamp/Intra-Cellular Recording |
| | | Screening |
| | | Surgery |
| | | Grating Rotation for (Dental) Imaging |
| 5 | METROL- | Scanning Interferometry |
| | OGY | White-Light Interferometry (Non-Contact |
| | | Measurement) |
| | | Precision Linear Positioning for Surface Analysis, |
| | | Vision Systems, etc. |
| | | Surface Scanning |
| | | Contacting Surface Profilometry |
| | | Autofocus Systems |
| | | Ellipsometry |
| 6 | MICRO | Precision Positioning (Linear & Rotation) of |
| | MACHIN- | Components |
| | ING | Precision Actuation |
| | | Micro-Grippers |
| | | Micro-Embossing |
| | | Micro-Assembly |
| | | Micro-Handling Systems |
| 7 | MICROS- | Scanning Microscopy (SNOM, AFM, |
| | COPY | E-Beam) |
| | | Long-Range Scanning |
| | | Confocal Microscopy |
| | | Sample Positioning (long range) |
| | | Sample Positioning (short range) |
| 8 | PHOTON- | Photonics Packaging, MEMS Alignment, Fiber |
| | ICS | Alignment, Fiber Optics Testing |
| | | Fiber Alignment Switching |
| | | Fiber Splicing |
| | | Fiber Stretching Modulation |
| | | Photonics Alignment (long range) |
| | | Beam Alignment, Beam Switching |
| 9 | PRECI- | Out-of-Roundness Turning/Boring/Grinding of |
| | SION | Optics, Bearings, Pistons, Shafts. |
| | MACHIN- | Wear Compensation of Grinding Wheels |
| | ING | Aspheric contact Lens, Manufacturing, Diamond |
| | | Turning |
| | | Focus/Beam Control for Laser Welding/Cutting |
| | | Vibration Cancellation |
| 10 | SEMI- | CD Measurement, Mask Alignment Objective |
| | CONDUC- | Alignment, Lithography |
| | TOR | Interferometry |
| | | Wire Bonding |
| | | Sub-nm Measurements |
| | | Lens Testing |
| | | Long-Range Nano-Alignment |
| | | Beam Scanning & Alignment, Optical Path |
| | | Correction |
| | | Active Vibration Cancellation |
| | | Vertical Wafer Positioning |
| | | Long-Range Positioning |

Results and Discussions: The design of nanopositioners has been reproduced as a fine tuned model as shown in FIG. 7. The total displacement of the stage was designed to be 50 micrometer in x axis (shown with arrow in drawing).

When the need for precise displacement in nanometer level, monolithic construction is essential. The design to achieve both as indicated earlier is tough and the design we have presented here satisfies both the requirements.

Merely actuating the monolithic stage at the center does not solve the issue of perpendicular deflection. In order to eliminate this perpendicular motion, compound spring system or inverted parallelogram has been used and actuation was done right middle on the inverted parallelogram in order to eliminate both ARCUATE & PERPENDICULAR deflections.

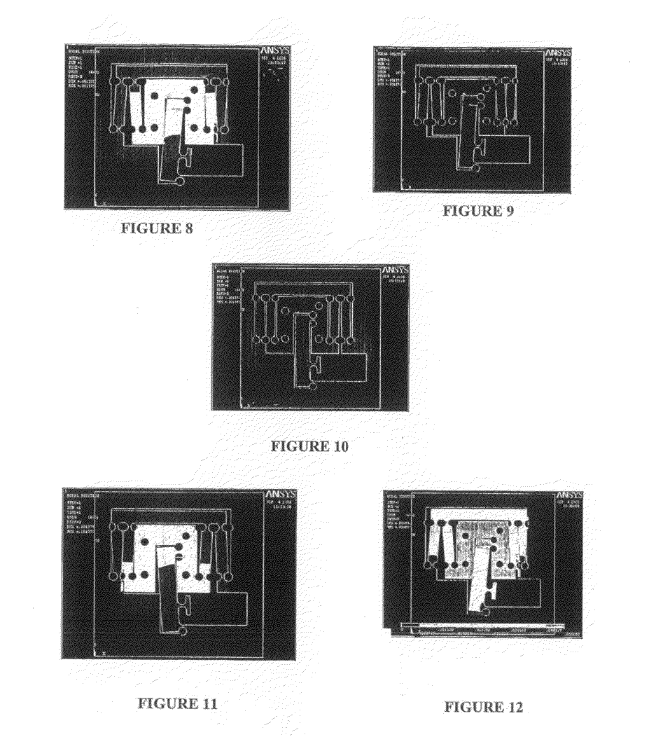

Analysis: The model has been reproduced on ANSYS 8.0 to simulate and compare with theoretical results. The arrow marked in the FIGS. 8-12 indicates the direction of displacement in X axis. From simulations it has been observed that the RED regions are exactly in the X axis unlike the other parts of monolithic components. The RED region is the place meant for precise nanopositioning in X (single) axis. BLUE indicates the fixed or immovable regions:The associated FIGS. 8-12 shows the step by step displacement from which one can understand the region which is shown using arrow, changes its color gradually i.e. no more than one color will be present in that region at any point of time.

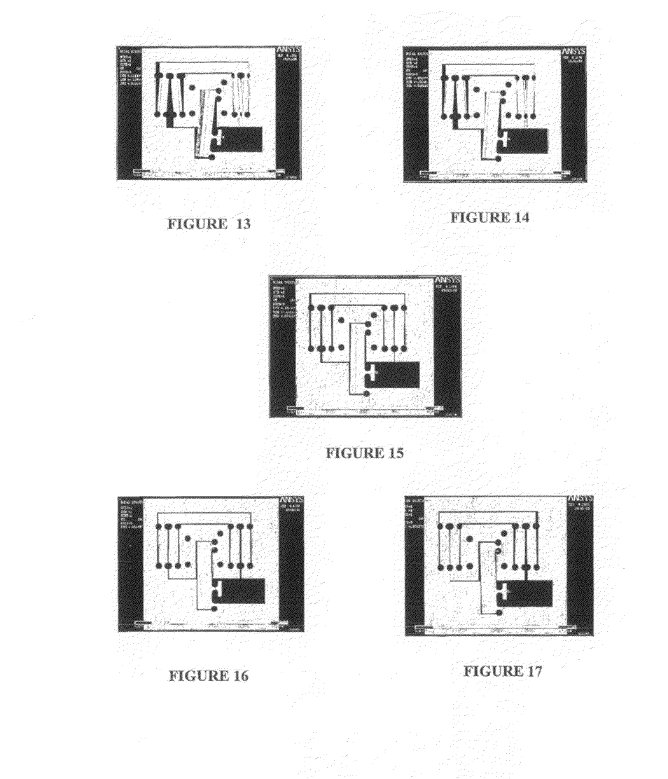

The simulation results observed in y direction shows that the region shown with arrow does not move in perpendicular direction as shown in FIGS. 13-17. At any point of time, the color remains the same i.e green.

If the inverted parallelogram and actuation at the middle were not achieved, the following errors are to be found. The (closer to theoretical) arcuate deflection for the nanopositioner was estimated to be 4.6 micro rad)(0.00026°) over the range of 5 micron and 9 micro rad (0.00052°) for 100 micron displacement. The perpendicular deflection was determined to be approximately 1% of the total range i.e 75 nm. These errors were eliminated by redesigning as mentioned earlier with the specifications of the nanopositioners (mechanical guide) given below.

| AXIS | X | |
|---|---|---|
| FORCE | 10 | Kg |
| DISPLACEMENT | 131 | micron |
| X(pos) | 10 | mm |
| X(lever) | 5 | mm |
| COLUMN LENGTH | 10 | mm |
| THICKNESS (HEIGHT) | 10 | mm |
| RESOLUTION | 1 | nm |
| WIDTH | 2.6 | mm |
| LEVER THICKNESS | 0.5 | mm |
| SIZE | 50 × 50 × 25 | |
| PAYLOAD | 1 | Kg |
| I-C LENGTH | 28 | mm |
| MATERIAL | STAINLESS STEAL | |
| R | 1 | mm |
| t | 0.6 | mm |

t < R < 5t

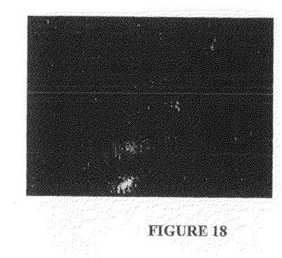

FIG. 18 shows the fringe that represents the measurement done with Laser Interferometry whose resolution is less than 1 nm. The fringes came closer which shows the presence of arcuate motion upto 0.08-0.09 micro rad over the range of 100 micron displacement. The same set up was used for measuring perpendicular motion during which the fringes were moving little upto 20 nm over the range of 100 micron displacement.

With these improved designs, the arcuate deflection was determined to be between 0.08-0.09 micro radians whereas the perpendicular deflection was 20 nm over the range of 100 micron in open loop condition. The deviation of results from the expected “zero” errors are due to manufacturing tolerances between 1-5 microns. The system was tested using Interferometry at Indian Institute of Technology, Madras, Chennai and with Atomic Force Microscopy (Vicco Inc.) at Jawaharlal Nehru Center for Advanced Science and Research, Bangalore, India.

### Advantages of the Invention

The expensive feedback systems, complex algorithm can be avoided.
Perfect linear movement can be obtained.
No additional actuator to counterbalance the arcuate motion is needed.
Size of the actuator can be controlled with amplifier.
Entire systems forms a monolithic structure and hence manufacturing process is relatively simple.

I claim:

1. An apparatus for moving an object in nanometer resolution in desired direction without any parasitic displacement with pure translational and rotational movements, said apparatus comprises inverted parallelograms to work as fixed stage and moving stage, flexural hinge carved at middle of the parallelograms to connect the stages to transfer the motion precisely and controllably, a piezo actuator to displace the moving stage, and amplification lever which comes out of the actuator and goes till the center of the parallelogram length to connect the actuator and the stages for amplifying the displacement derived from the piezo to predetermined displacement range.

2. The apparatus as claimed in claim 1, wherein the apparatus is monolithic.

3. The apparatus as claimed in claim 1, wherein the parallelogram used is a four-bar-chain mechanism.

4. The apparatus as claimed in claim 1, wherein the moving stage of the first parallelogram act as a fixed stage for the second parallelogram.

5. The apparatus as claimed in claim 1, wherein predetermined part of moving stage is cut into step for free movement and grounded for smooth surface.

6. The apparatus as claimed in claim 1, wherein the actuator is fabricated separately and assembled into apparatus.

7. The apparatus as claimed in claim 1, wherein size of the actuator is controlled with the amplification lever.

8. The apparatus as claimed in claim 1, wherein the piezo actuator acts like a motor.

9. The apparatus as claimed in claim 1, wherein the piezo actuator is piezo crystal(s) in a housing.

10. A method for moving an object in nanometer resolution in desired direction without any parasitic displacement with pure translational and rotational movements, said method comprises steps of;
i. keeping the object over a moving stage of parallelograms,
ii. deflecting amplification lever using actuator for displacement of the moving stage,
iii. actuating both parallelograms at the center of column length by deflected amplification lever, and
iv. moving the actuated parallelograms in a desired direction

11. The method as claimed in claim 11, wherein the parallelograms used is a four-bar-chain mechanism.

12. The method as claimed in claim 11, wherein the parallelograms are inverted to each other.

13. The method as claimed in claim 11, wherein the moving stage of the first parallelogram act as a fixed stage for the second parallelogram.

14. The method as claimed in claim 11, wherein the amplifier comes out of the actuator and goes till the center of the parallelogram length.

15. The method as claimed in claim 11, wherein the apparatus does not require any feed back control systems.

16. The method as claimed in claim 11, wherein the apparatus does not require additional actuators to counterbalance arcuate motion.

17. The method as claimed in claim 10, wherein the amplification lever amplifies the displacement of the moving stage to predetermined range.

18. A method of manufacturing an apparatus for moving an object in nanometer resolution in desired direction without any parasitic displacement with pure translational and rotational movements, said method comprises;
i. Connecting fixed stage and moving stage of inverted parallelograms by means of flexural hinge carved at middle of the parallelograms,
ii. Connecting an actuator and the stages by means of an amplification lever which comes out of the actuator and goes till the center of the parallelogram length for amplifying the displacement derived from the piezo to predetermined displacement range, and
iii. Combining a mechanical stage with the parallelograms to transfer the motion precisely and controllably to obtain the apparatus.
